(19) United States
(12) Patent Application Publication
(10) Pub. No.: US 2015/0044402 A1
(43) Pub. Date: Feb. 12, 2015

(54) SNAP TOGETHER STRUCTURAL COMPONENT

(71) Applicant: Cutting Dynamics, Inc., Avon, OH (US)

(72) Inventors: William V. Carson, JR., Bay Village, OH (US); George Bielert, San Jose, CA (US)

(21) Appl. No.: 14/386,386

(22) PCT Filed: Mar. 22, 2013
(86) PCT No.: PCT/US13/33518

§ 371 Date: Sep. 19, 2014

Related U.S. Application Data
(60) Provisional application No. 61/615,040, filed on Mar. 23, 2012.
(60) Provisional application No. 61/615,000, filed on Mar. 23, 2012.

(51) Int. Cl. B60N 2/68; B29C 65/48; B29D 99/00; B64D 11/06

(52) U.S. Cl. CPC B60N 2/68; B64D 11/06; B29C 65/4805; B29D 99/0092; B64D 2011/0603; B29K 2307/04
USPC 428/34.5; 428/36.4; 156/245

(57) ABSTRACT

Disclosed in this specification is an article of manufacture comprising at least two longitudinal sections comprising a thermoplastic matrix of randomly dispersed carbon fibers forming the article of manufacture, with the structure reinforced by affixing a pad up of a thermoplastic matrix comprising oriented fibers to at least one of the longitudinal sections. The at least two longitudinal sections are assembled to form the article of manufacture by the interaction of adjoining structures on one longitudinal section with adjoining structures on the other longitudinal section.

### CROSS REFERENCES AND PRIORITIES

This application claims priority from U.S. Provisional Application No. 61/615,040 filed on 23 Mar. 2012 and U.S. Provisional Application No. 61/615,000 filed on 23 Mar. 2012, the teachings of both of which are incorporated in their entirety.

### BACKGROUND

Replacing metal and heavy parts with plastic parts is common. However, when the part takes on odd shapes or needs structural strength replacement with plastic becomes more difficult. The use of fibers to reinforce the plastic is a common practice, with oriented fibers known to be stronger than unoriented fibers.

One such challenging article is the seat frame used in airplanes. Seat frames must bear a large load. Imagine the frame locked to the floor, with a person sitting in it, and the person behind the seat grasping the seat and using it to assist lifting him or herself out of the seat. The amount of torque on the support or weakest spot of the frame is quite large.

Many have tried to make a seat back using thermoset composites reinforced with fibers. Thermoset composites are time consuming to process with low throughput and increased costs. Efforts to increase the time have resulted in increased weight of the final part, making it unappealing to the airline industry.

WO 2010 111700 published 30 Sep. 2010 discloses one method of incorporating oriented strength enhancing carbon fibers. This method used a pre-formed tube of the fibers in a thermoplastic matrix, expanded the tube in a heated mold allowing the thermoplastic to set up in the “U” shape of the seat back.

This method is expensive and overdesigns strength where strength is not needed.

### SUMMARY

Disclosed in this specification is an article of manufacture comprising at least a first longitudinal section and a second longitudinal section, wherein the first longitudinal section has a first longitudinal section length dimension, a first longitudinal section width dimension, a first longitudinal section height dimension, one or more first longitudinal section thicknesses, two first longitudinal section edges corresponding to the first longitudinal section length dimension and a first thermoplastic matrix comprised of randomly dispersed fibers of the first longitudinal section, the first longitudinal section further comprising: at least one first adjoining structure selected from the group consisting of an adjoining initiator, an adjoining receiver or combinations thereof wherein the second longitudinal section has a second longitudinal section length dimension, a second longitudinal section width dimension, a second longitudinal section height dimension, one or more second longitudinal section thicknesses, two second longitudinal section edges corresponding to the second longitudinal section length dimension and a second thermoplastic matrix comprised of randomly dispersed fibers of the second longitudinal section, the second longitudinal section further comprising at least one second adjoining structure selected from the group consisting of an adjoining initiator, an adjoining receiver or combinations thereof wherein the at least one first adjoining structure is designed to interact with the at least one second adjoining structure such that the at least one first adjoining structure joins with the at least one second adjoining structure to form an assembly comprising at least the first longitudinal section and the second longitudinal section wherein the assembly comprises a channel having a bottom, side walls, and a top each having interior surfaces which define a hollow interior.

In one embodiment, the at least first longitudinal section and second longitudinal section are produced by injection molding.

In one embodiment at least one of the first longitudinal section and the second longitudinal section comprises at least one pad-up. In a further embodiment the at least one pad-up is comprised of a third thermoplastic matrix comprised of oriented fibers. In a further embodiment the at least one pad-up is affixed to at least one of the first longitudinal section and the second longitudinal section by over molding. In another embodiment the at least one pad-up is affixed to at least one of the first longitudinal section and the second longitudinal section by insert molding.

In one embodiment the first adjoining structure and the second adjoining structure are selected from the group consisting of an adjoining initiator tongue and an adjoining receiver groove; an adjoining initiator pin and an adjoining receiver pin receiver; an adjoining initiator tab and an adjoining receiver tab receiver. In another embodiment the first adjoining structure and the second adjoining structure further comprise an adjoining structure assistant selected from the group consisting of an adhesive material, welding or combinations thereof.

In one embodiment the at least one first adjoining structure comprises a plurality of first adjoining structures and the at least one second adjoining structure comprises a plurality of second adjoining structures. In a further embodiment the plurality of first adjoining structures consists of at least one adjoining structure initiator and at least one adjoining structure receiver which alternate along at least a portion of at least one edge of the first longitudinal section and the plurality of second adjoining structures consists of at least one adjoining structure initiator and at least one adjoining structure receiver which alternate along at least a portion of at least one edge of the second longitudinal section. In still a further embodiment the first adjoining structure runs the entire length of at least one edge of the first longitudinal section and the second adjoining structure runs the entire length of at least one edge of the second longitudinal section.

In one embodiment the first thermoplastic matrix, the second thermoplastic matrix and the third thermoplastic matrix each comprise a thermoplastic selected from the group consisting of polyphenylene sulphide, polyetherimide, polyetheretherketone, polyetherketoneketone, polyethylene terephthalate, polyester, polybutylene terephthalate, polyethylene naphthalate, polyethersulfone and combinations thereof.

In one embodiment the randomly dispersed fiber types of the first thermoplastic matrix and the second thermoplastic matrix each comprise a fiber type selected from the group consisting of carbon fibers, glass fibers, polyaramide fibers and combinations thereof. In a further embodiment the amount of randomly dispersed fibers in the first thermoplastic matrix and the second thermoplastic matrix is each between 5% and 60% by weight of the respective first and second longitudinal sections. In still a further embodiment the oriented fibers comprises a fiber type selected from the group consisting of carbon fibers, glass fibers, polyaramide fibers and combinations thereof.

In one embodiment the first longitudinal section and the second longitudinal section each comprise a “J” shaped longitudinal section. In another embodiment there are at least a third longitudinal section and a four longitudinal section wherein the first longitudinal section, the second longitudinal section, the third longitudinal section and the forth longitudinal section each comprise an “I” shaped longitudinal section. In a further embodiment the first longitudinal section length dimension and the second longitudinal section length dimension are the same length dimension and the first longitudinal section and the second longitudinal section are mirror images wherein the first longitudinal section and the second longitudinal section are interlocked with each other to form the channel. In another embodiment the first longitudinal section comprises a “U” shaped longitudinal section and the second longitudinal section comprises an “I” shaped longitudinal section.

In one embodiment the article of manufacture is an assembly comprising at least the first longitudinal section and the second longitudinal section to form a “U” shaped member comprised of a first leg section, a second leg section and a top section joining the first leg section and the second leg section. In a further embodiment the article of manufacture is an assembly comprising at least the first longitudinal section, the second longitudinal section and a third longitudinal section and a fourth longitudinal section to form a “U” shaped member having a first leg section, a second leg section and a top section joining the first leg section and the second leg section, wherein the third longitudinal section has a third longitudinal section length dimension, a third longitudinal section width dimension, a third longitudinal section height dimension, one or more third longitudinal section thicknesses, two third longitudinal section edges corresponding to the third longitudinal section length dimension and a fourth thermoplastic matrix comprised of randomly dispersed fibers of the third longitudinal section, the third longitudinal section further comprising: at least one third adjoining structure selected from the group consisting of an adjoining initiator, an adjoining receiver or combinations thereof wherein the fourth longitudinal section has a fourth longitudinal section length dimension, a fourth longitudinal section width dimension, a fourth longitudinal section height dimension, one or more fourth longitudinal section thicknesses, two fourth longitudinal section edges corresponding to the fourth longitudinal section length dimension and a fifth thermoplastic matrix comprised of randomly dispersed fibers of the fourth longitudinal section, the fourth longitudinal section further comprising at least one fourth adjoining structure selected from the group consisting of an adjoining initiator, an adjoining receiver or combinations thereof wherein the first longitudinal section and the second longitudinal section are mirror images and the third longitudinal section and the forth longitudinal section are mirror images wherein at least a portion of the first adjoining structure of the first longitudinal section interacts with at least a portion of the second adjoining structure of the second longitudinal section and at least a portion of the third adjoining structure of the third longitudinal section to form the first leg section and at least a portion of the top section and the second adjoining structure of the second longitudinal section interacts with at least a portion of the first adjoining structure of the first longitudinal section and at least a portion of the fourth adjoining structure of the fourth longitudinal section to form the second leg section and at least a portion of the top section.

In one embodiment the first leg section has a first leg stress location and a first leg pad-up located at the first leg stress location. In a further embodiment the second leg section has a second leg stress location and a second leg pad-up located at the second leg stress location. In a further embodiment the top section has a top section stress location and a top section pad-up located at the top section stress location.

In one embodiment the article of manufacture is used as an airplane seat back.

Also disclosed herein is a process to manufacture an article comprising the steps of
A) Molding at least a first longitudinal section and a second longitudinal section wherein the first longitudinal section has a first longitudinal section length dimension, a first longitudinal section width dimension, a first longitudinal section height dimension, one or more first longitudinal section thicknesses, and a first thermoplastic matrix comprised of randomly dispersed fibers, the first longitudinal section further comprising, at least one first adjoining structure selected from the group consisting of an adjoining initiator, an adjoining receiver or combinations thereof, and the second longitudinal section has a second longitudinal section length dimension, a second longitudinal section width dimension, a second longitudinal section height dimension, one or more second longitudinal section thicknesses, and a second thermoplastic matrix comprised of randomly dispersed fibers, the second longitudinal section further comprising, at least one second adjoining structure selected from the group consisting of an adjoining initiator, an adjoining receiver or combinations thereof, and
B) Adjoining the at least a first longitudinal section and a second longitudinal section at at least the first adjoining structure and the second adjoining structure to form one continuous article of manufacture.

In one embodiment the first thermoplastic matrix and the second thermoplastic matrix comprise a thermoplastic selected from the group consisting of polyphenylene sulphide, polyetherimide, polyetheretherketone, polyetherketoneketone, polyethylene terephthalate, polyester, polybutylene terephthalate, polyethylene naphthalate and combinations thereof.

In one embodiment the randomly dispersed fibers comprise a fiber type selected from the group consisting of carbon fiber, glass fiber, polyaramide fiber and combinations thereof.

In one embodiment the first adjoining structure and the second adjoining structure are selected from the group consisting of an adjoining initiator tongue and an adjoining receiver groove; an adjoining initiator pin and an adjoining receiver pin receiver; an adjoining initiator tab and an adjoining receiver tab receiver or combinations thereof. In a further embodiment the first adjoining structure and the second adjoining structure further comprise an adjoining structure assistant selected from the group consisting of an adhesive material, welding or combinations thereof.

In one embodiment molding the thermoplastic matrix comprised of random fibers into at least the first longitudinal section and the second longitudinal section comprises injection molding.

In one embodiment at least one of the at least a first longitudinal section and a second longitudinal section further comprises at least one pad-up. In a further embodiment the at least one pad-up is comprised of a third thermoplastic matrix and oriented fibers. In a further embodiment the third thermoplastic matrix comprises a thermoplastic selected from the group consisting of polyphenylene sulphide, polyetherimide, polyetheretherketone, polyetherketoneketone, polyethylene terephthalate, polyester, polybutylene terephthalate, polyethylene naphthalate and combinations thereof. In a further embodiment the oriented fibers comprise a fiber type selected from the group consisting of carbon fibers, glass fibers, polyaramide fibers and combinations thereof.

In one embodiment the at least one pad-up is over molded into the at least a first longitudinal section or a second longitudinal section. In another embodiment the at least one pad-up is insert molded into the at least a first longitudinal section or a second longitudinal section.

### BRIEF DESCRIPTION OF FIGURES

FIG. 1 is a view of two assembled longitudinal sections

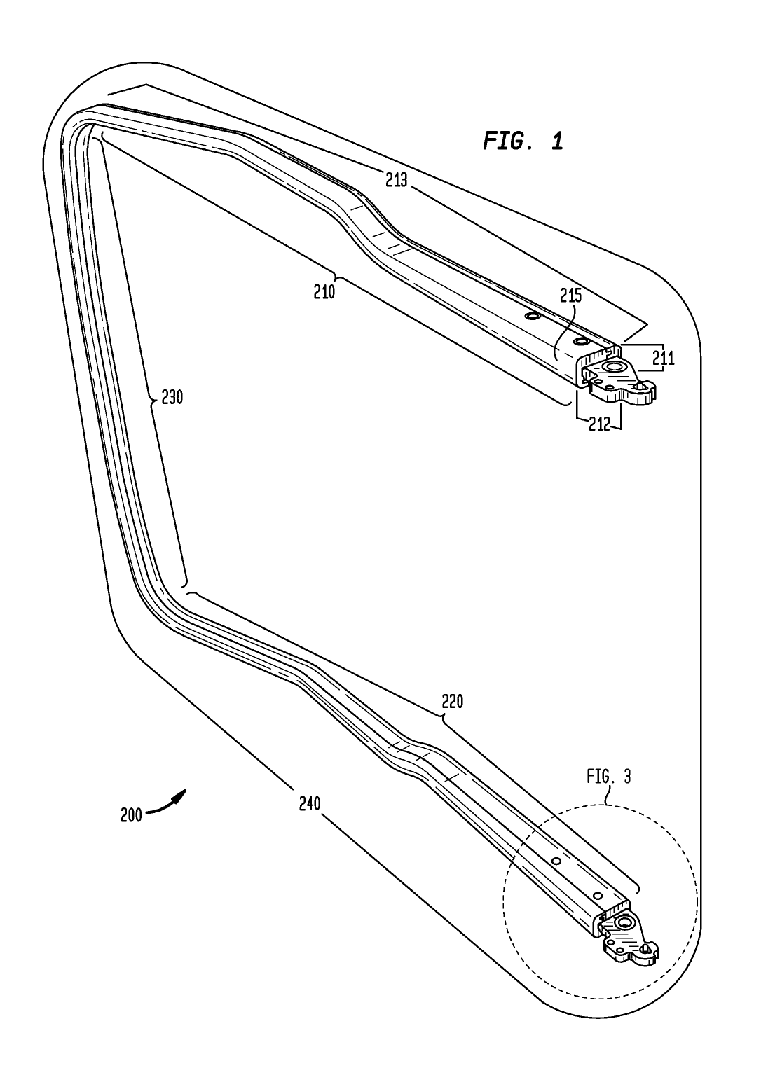

FIG. 2 is a view of two disassembled longitudinal sections

FIG. 3 is a view of a plurality of disassembled longitudinal sections

FIG. 4 is a view of the end of two assembled longitudinal sections

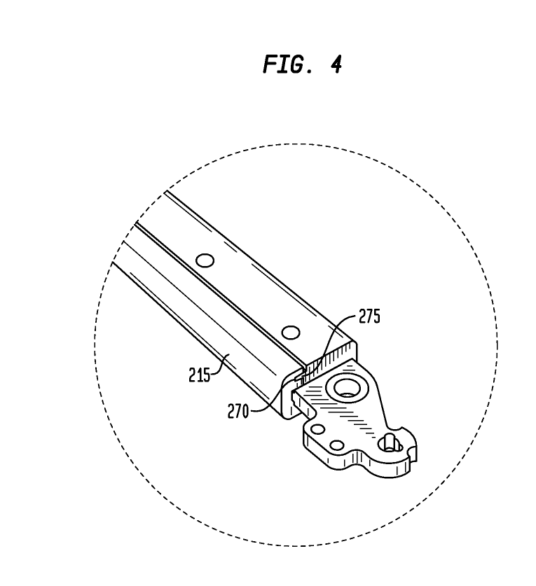

FIG. 5 is a perspective view of two assembled longitudinal sections

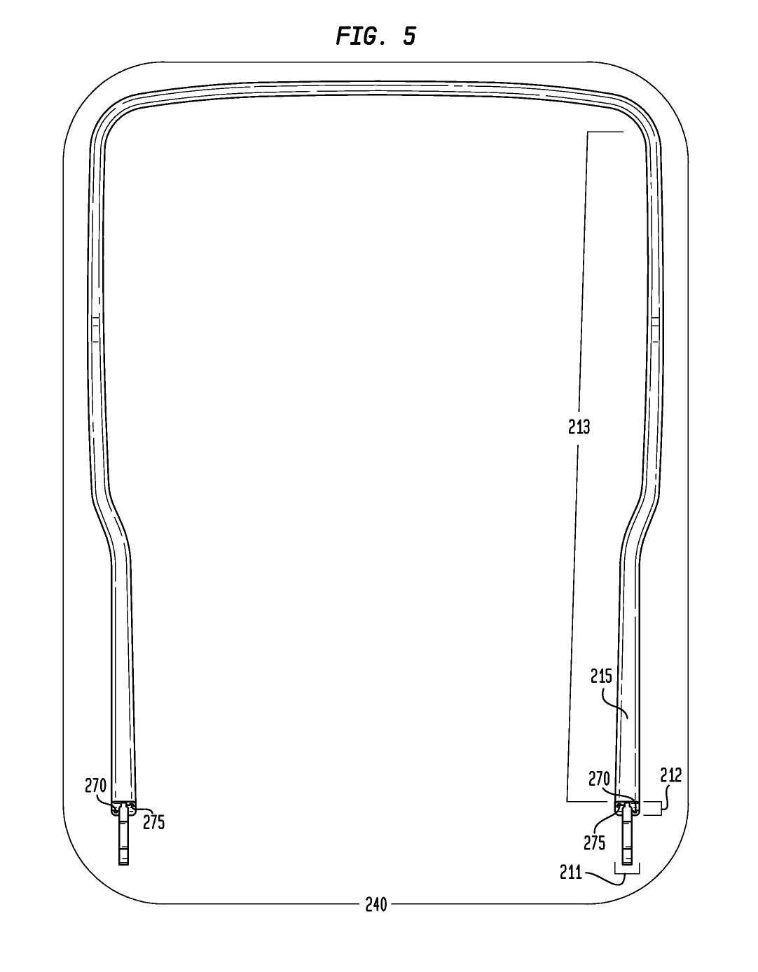

FIG. 6 is an side view of two assembled longitudinal sections

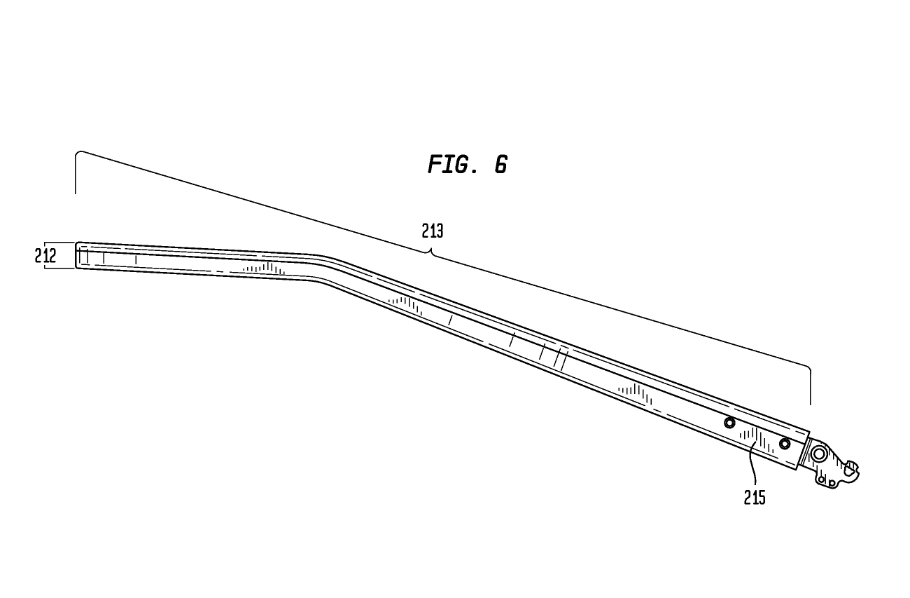

FIG. 7 is an end view of two assembled longitudinal sections FIG. 8 is another end view of two assembled longitudinal sections

FIG. 9 is an end view of four assembled longitudinal sections

FIG. 10 is another end view of two assembled longitudinal sections

FIG. 11 is a view of two disassembled longitudinal sections comprising pad-ups

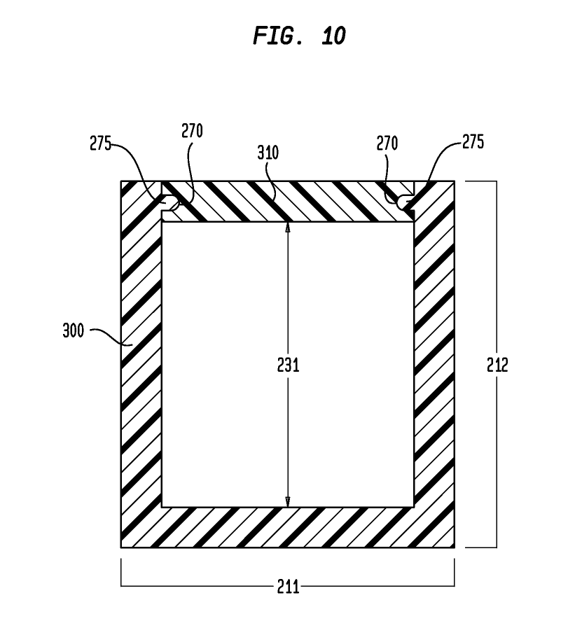

FIG. 12 is a cut-away view of a pad-up molded into a longitudinal section

FIG. 13 is a cut-away end view of a pad-up molded into a longitudinal section

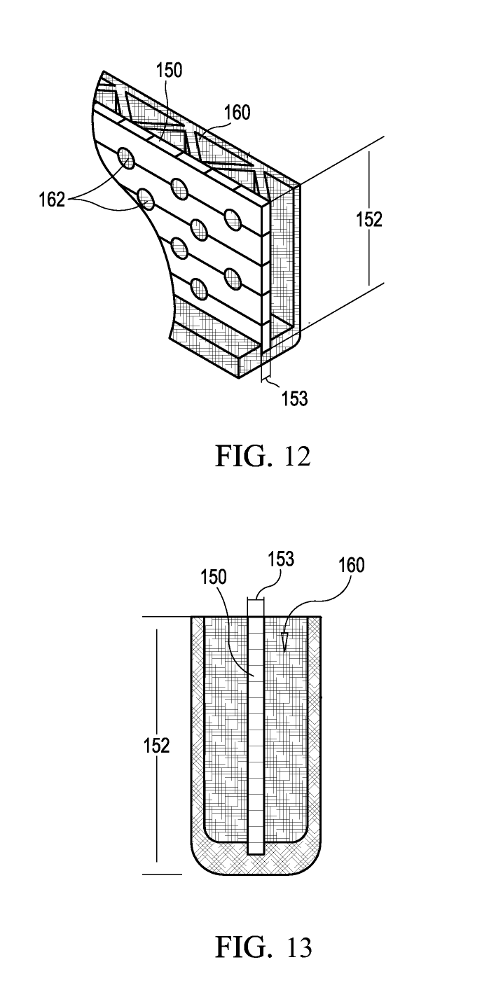

### DETAILED DESCRIPTION

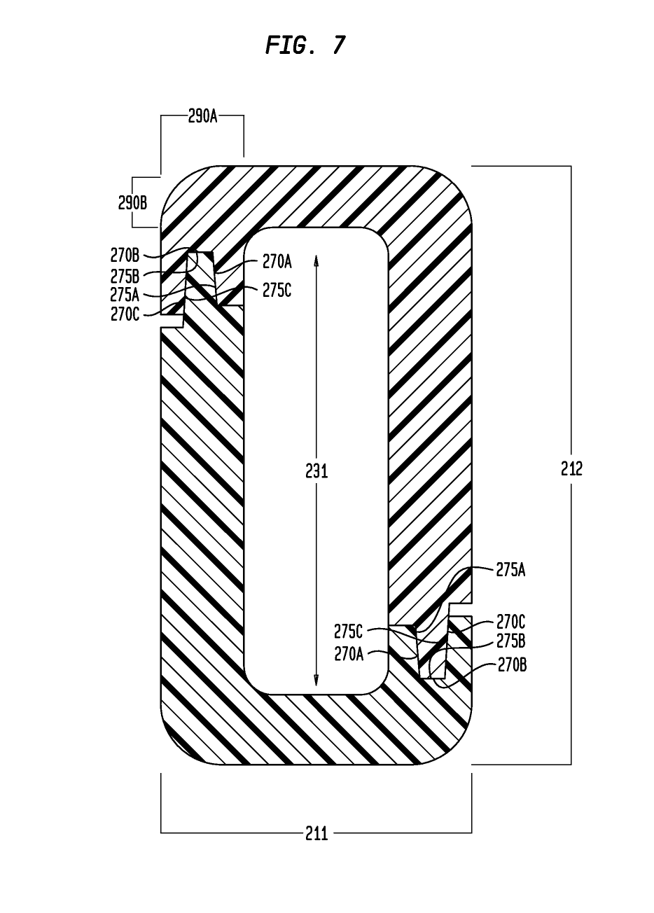

This specification discloses an article of manufacture comprising at least a first longitudinal section and at least a second longitudinal section (280) wherein the first longitudinal section comprises a first thermoplastic matrix comprised of randomly dispersed fibers and at least one first adjoining structure selected from the group consisting of an adjoining initiator, an adjoining receiver or combinations thereof, and the second longitudinal section comprises a second thermoplastic matrix comprised of randomly dispersed fibers and at least one second adjoining structure selected from the group consisting of an adjoining initiator, an adjoining receiver or combinations thereof. Optionally, either or both of the first longitudinal section and the second longitudinal section may comprise at least one pad-up located at a point on the longitudinal section without at least one pad-up where the longitudinal section is prone to structurally failing. Both the first longitudinal section and the second longitudinal section may have a plurality of longitudinal section thicknesses (See by way of example, FIG. 7, 290A and 290B). In a preferred embodiment of the present invention at least a portion of the article of manufacture is in the shape of a channel (231) having a base or bottom, side walls and a top, each having interior surfaces which define a hollow interior as seen in FIGS. 7 through 10 showing end views of various embodiments of the claimed invention.

The article of manufacture and process to manufacture the article relies upon the discovery that randomly dispersed fibers in a thermoplastic matrix can be injection molded or pultrusion molded into inexpensive, easy to assemble parts which can be assembled into a hollow structural component having adequate strength for applications such as an airplane seat back.

All references herein to the drawings are examples of embodiments only. The current invention is not limited to those embodiments referred to in the drawings.

### Longitudinal Sections

Both the first longitudinal section and the second longitudinal section will have a longitudinal section length dimension (281), a longitudinal section width dimension (282), a longitudinal section height dimension (283), one or more longitudinal section thicknesses (See by way of example, FIG. 7, 290A and 290B) and two longitudinal section edges. The length dimension of each longitudinal section will be the longest dimension of each of the longitudinal sections. The width dimension of each longitudinal section is the dimension traveling perpendicular to the length dimension in the longitudinal section horizontal plane. The height dimension of each longitudinal section is the dimension perpendicular to the longitudinal section horizontal plane. The two longitudinal section edges are on opposite sides of one another and therefore oppose one another and corresponds to the longitudinal section length dimension.

The one or more longitudinal section thicknesses (See by way of example, FIG. 7, 290A and 290B) can be varied depending upon the desired strength of the article and the need to conserve materials. For any given article of manufacture, the longitudinal section thickness may be varied depending upon the need for increased strength at a point on the longitudinal section that is prone to structurally failing. Typically, a longitudinal section may fail at a stress location along the longitudinal section where the longitudinal section becomes permanently distorted from its original shape when a force is applied to the longitudinal section, which is usually observed as a kink, a collapse, or the propagation of a crack. Once a stress location is determined, the longitudinal section thickness can be increased at the stress location to provide for increased strength. In one embodiment, the longitudinal section thickness are not varied.

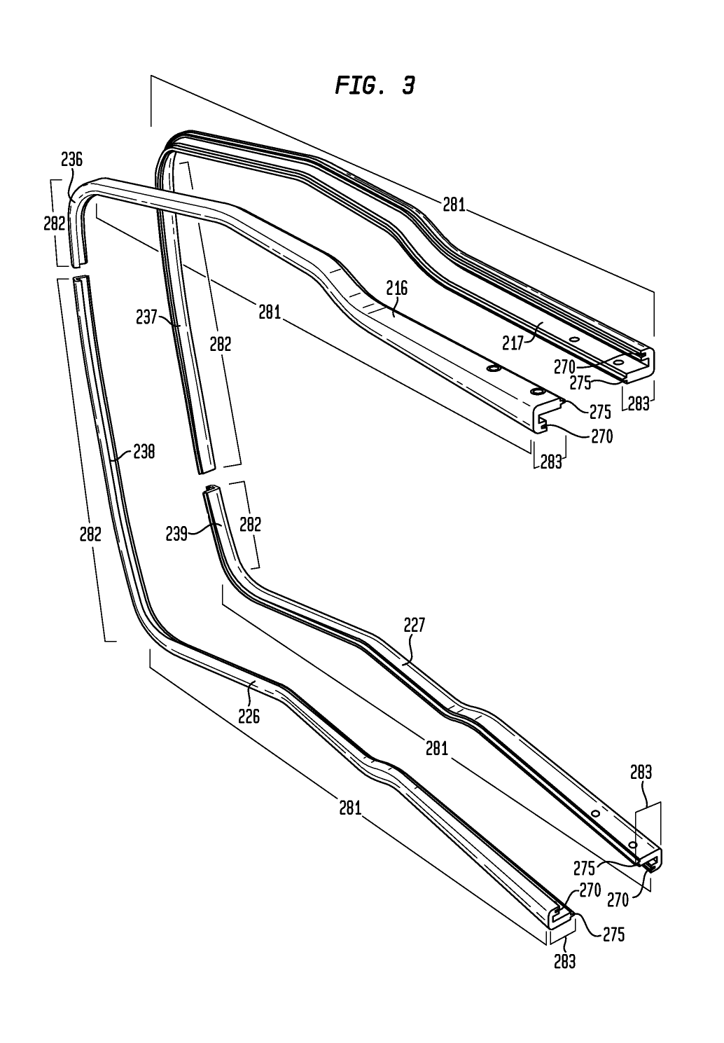

In one embodiment, the first longitudinal section length dimension and the second longitudinal section length dimension are the same length dimension and the first longitudinal section and second longitudinal section are mirror images where the first longitudinal section and the second longitudinal section can interlock with each other to form the channel. By mirror images, it is meant that the same mold can be used to create both the first longitudinal section and the second longitudinal section so that, when one of the longitudinal sections is flipped upside down, it can adjoin with the other longitudinal section to form one assembly. In an embodiment where there are more than two longitudinal sections, for instance, four longitudinal section, as seen in FIG. 3, the first longitudinal section (217) may be the mirror image of the second longitudinal section (226) while the third longitudinal section (216) may be the mirror of the fourth longitudinal section (227). By forming at least two of the longitudinal sections in a mirror design, the same mold can be used to make more than one longitudinal section for assembling into the article of manufacture, thereby reducing the cost associated with having separate molds for each longitudinal section.

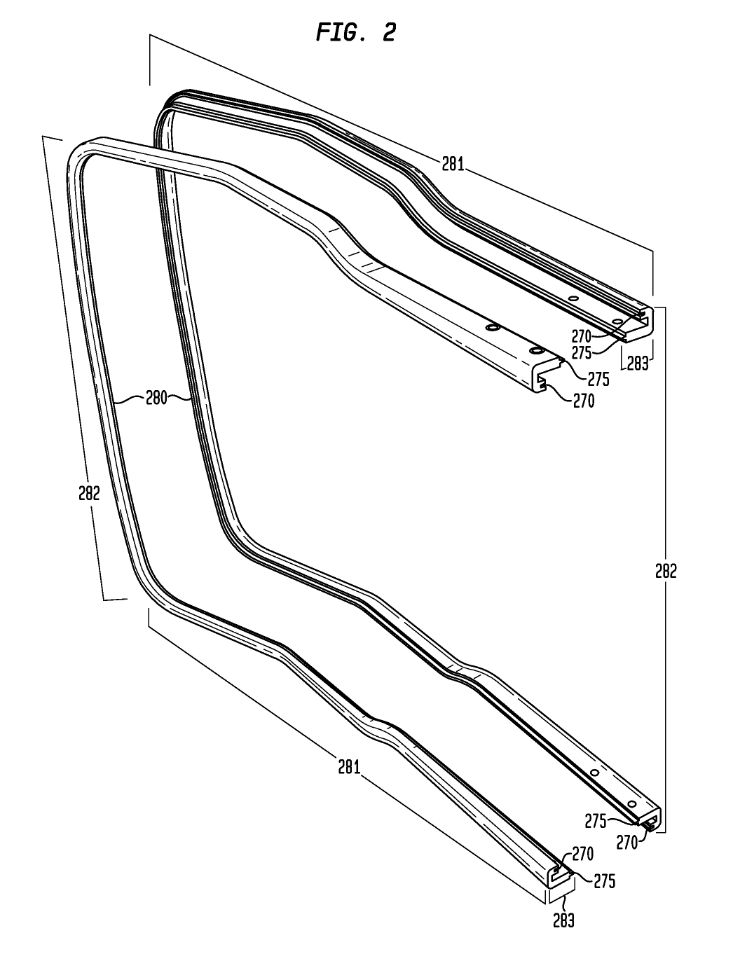

In one embodiment, the longitudinal sections may be formed into a “J” shape. “J” shaped longitudinal sections provide for increased strength when the at least two longitudinal sections are joined to form the finished article. This is because the location of the adjoining structures on either side of the finished article are offset from one another as seen in FIG. 2.

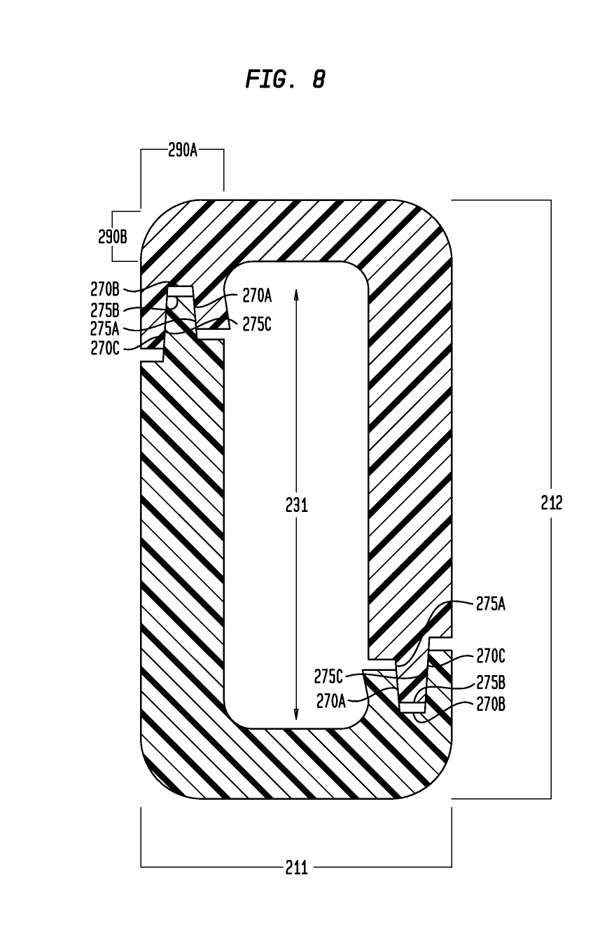

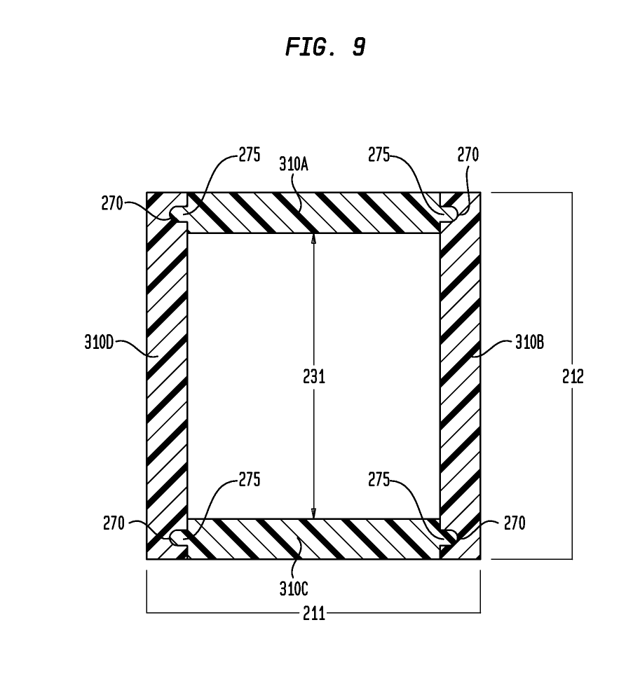

In one embodiment the article of manufacture may form a channel comprised of two “J” shaped longitudinal sections as seen in FIG. 7. In another embodiment, the article of manufacture may form a channel comprised of more than two longitudinal sections, for instance a channel comprised of four “I” shaped longitudinal sections (as seen in FIG. 9, 310A, 310B, 310C and 310D) as seen in FIG. 9. In another embodiment, the channel is formed between a “U” shaped longitudinal section (300) and an “I” shaped longitudinal section (310) as seen in FIG. 10.

The article of manufacture may be an airplane seat frame (200). It is well established that a frame for a seat back, particularly for use in aircraft will often be in a “U” shape comprising two leg sections and a top section (230). The first leg section (210) will have a first leg section stress location and the second leg section (220) will have a second leg section stress location. 240 denotes the plane formed by the first leg section, the second leg section, and the top section or the “U” shaped member horizontal plane.

The first leg section will have a first leg section width dimension (211), a first leg section height dimension (212), and a first leg section length dimension (213). The length dimension will be the longest dimension. The width dimension is the dimension travelling perpendicular to the length dimension, lying in the “U” shaped member horizontal plane defined by the first leg section, the second leg section and the top section (240) which connects or joins the first and second leg sections. The first and second leg section horizontal dimensions are perpendicular to the “U” shaped member horizontal plane.

The top section (230) could be a straight piece, or a curved piece that transitions from the second end of the first leg section, running in the “U” shaped member horizontal plane and then transitions into the second end of the second leg section.

In one embodiment, the first leg section (210), the second leg section (220) and the top section (230) are comprised of the first longitudinal section and the second longitudinal section where the at least one first adjoining structure joins with the at least one second adjoining structure to form an assembly comprising at least the first longitudinal section and the second longitudinal section which is the “U” shaped member as seen in FIG. 2.

In a more elegant embodiment, the first leg section (210), the second leg section (220) and the top section (230) are comprised of four longitudinal sections. In such an embodiment it is preferred that the first longitudinal section (217) is the mirror image of the second longitudinal section (226) and the third longitudinal section (216) is the mirror image of the fourth longitudinal section (227) as seen in FIG. 3. In this embodiment, the first adjoining structure of the first longitudinal section interacts with at least a portion of the second adjoining structure of the second longitudinal section and at least a portion of the third adjoining structure of the third longitudinal section to form the first leg section (210) and at least a portion of the top section (comprising 236 and 237 as seen in FIG. 3). Also, the second adjoining structure of the second longitudinal section interacts with at least a portion of the first adjoining structure of the first longitudinal section and at least a portion of the fourth adjoining structure of the fourth longitudinal section to form the second leg section (220) and at least a portion of the top section (comprising 238 and 239 as seen in FIG. 3).

For clarity, the first leg section will have a first leg section first end (215). The second leg section is usually of similar, or even like or the same dimensional design as the first leg section. The second leg section will have a second leg section length dimension, a second leg section width dimension and a second leg section height dimension, wherein the second leg section length dimension is the longest dimension of the second leg section, the second leg section further having a second leg section first end.

### Adjoining Structures

Each of the longitudinal sections of the article of manufacture is further comprised of at least one adjoining structure selected from the group consisting of an adjoining initiator, an adjoining receiver or combinations thereof. An adjoining structure is one of two physical elements one of which is attached to a first longitudinal section, the other of which is attached to a second longitudinal section where the adjoining structure of the first longitudinal section interacts with the adjoining structure of the second longitudinal section. The interaction could include, but is not limited to, friction between the two adjoining structures, deformation of one or more of the structures against the other adjoining structure to create pressure and friction, adhesion interaction, or a physical restraint of one adjoining section with the other adjoining section. The two types of adjoining structures are an adjoining initiator which extends or protrudes from the surface or edge of one longitudinal section and an adjoining receiver which is recessed into the surface or edge of another longitudinal section. A hole, because of its passing through a longitudinal section, is considered an adjoining receiver because it is a recession into the surface, even though it does not contain a bottom.

An example of interaction by friction are tongue and groove adjoining structures where the tongue is the adjoining initiator protruding from the surface or the edge of one longitudinal section and the groove is the adjoining receiver recessed into the surface or the edge of another longitudinal section. In the friction interaction system, the adjoining initiator would come in contact with the adjoining receiver. FIG. 7 is an example of an interaction by friction.

An example of interaction by deformation causing friction are tongue and groove adjoining structures where the tongue is the adjoining initiator protruding from the surface or the edge of one longitudinal section and the groove is the adjoining receiver recessed into the surface or the edge of another longitudinal section. In this example, the tongue has a top (275B) having a width and the groove has a bottom (270B) having a width where the width of the top is greater than the width of the bottom thereby causing the groove to deform when the tongue interacts with the groove as seen in FIG. 8.

An example of an adhesion interaction would require the additional element of an adhesive material. Referring to FIG. 8 the gap between 275B and 270B would contain the adhesive material where the adhesive material lies between the surface of the adjoining initiator and the adjoining receiver where the adjoining initiator and the adjoining receiver are not in direct contact. In the bonded alternative the initiator and the receiver are molded together to where at least a portion of the initiator is blended with at least a portion of the receiver such as in welding or chemically bonding.

An example of a physical restraining interaction are pin and pin receiver adjoining structures where the pin is the adjoining initiator protruding from the surface or the edge of one longitudinal section and the pin receiver is the adjoining receiver recessed into the surface or the edge of another longitudinal structure. The pin having a pin diameter and the pin receiver being in the form of a hole having a pin receiver hole diameter where the pin receiver hole diameter is smaller than the pin diameter such that when the pin is placed into the pin receiver hole the pin cannot pass back through the pin hole thereby removing the pin from the pin receiver.

In one embodiment the adjoining structures lie on at least one of the two longitudinal section edges. In another embodiment an adjoining structure will run the entire length of its longitudinal section edge. (see FIG. 3). In a further embodiment the adjoining structures lie on both of the two longitudinal section edges. In another embodiment the adjoining structures run the entire length of both of the two longitudinal section edges. The adjoining structure on any one of the longitudinal section edges may be an adjoining structure initiator, an adjoining structure receiver or a combination of at least one adjoining structure initiator and at least one adjoining structure receiver. In one embodiment, at least one of the two longitudinal section edges may have alternating adjoining structure initiators and adjoining structure receivers.

Where at least two of the longitudinal sections are mirror images, the adjoining structure on one edge of each longitudinal section will be an adjoining structure initiator while the adjoining structure on the opposing edge of each longitudinal section will be an adjoining receiver. When the at least two longitudinal sections are assembled to make a finished product, the adjoining structure receiver on one edge of one longitudinal section will interact with the adjoining structure initiator on one edge of the other longitudinal section. The adjoining structure initiator on the opposing edge of one longitudinal section will then interact with the adjoining structure receiver on the opposing edge of the other longitudinal section.

Where at least two of the longitudinal sections are mirror images having alternating adjoining structure initiators and adjoining structure receivers, the alternating adjoining structure initiators and adjoining structure receivers on one edges of the first longitudinal section will match and interact with the alternating adjoining structure initiators and adjoining structure receivers on one edge of the second longitudinal section when the at least two longitudinal sections are assembled to make a finished product.

For clarity, it is not necessary for any one longitudinal section to have both an adjoining initiator and an adjoining receiver. All that is required is that at least one adjoining initiator of one longitudinal section is designed to interact with at least one adjoining receiver of a different longitudinal section to join at least the two longitudinal sections together to form an assembly comprising the at least two longitudinal sections.

Many embodiments exist in which one longitudinal section has only an adjoining initiator or a plurality of adjoining initiators while another longitudinal section has only an adjoining receiver or a plurality of adjoining receivers. Alternatively, embodiments exist in which one or more of the longitudinal sections has both an adjoining initiator and an adjoining receiver. Preferably, the adjoining structures in each longitudinal section will lie on the edge of the longitudinal section. In one embodiment, the longitudinal section has at least two edges where the adjoining structures lie on each of the at least two edges. It is also possible for the adjoining structures to lie inside the longitudinal section such that the adjoining structures are joined within the hollow interior of the channel of the finished product. It is also possible for the adjoining structures to lie both inside the longitudinal section and on one or more of the edges of the longitudinal section.

The at least one adjoining initiator and the at least one adjoining receiver of each longitudinal section may be selected from the group consisting of a tongue which is an adjoining initiator and a groove which is an adjoining receiver; a pin which is an adjoining initiator and a pin receiver which is an adjoining receiver; a tab which is an adjoining initiator and a tab receiver which is an adjoining receiver or combinations thereof. Where additional protection against separation of the longitudinal sections is desired, an adjoining structure assistant may be used. Preferred adjoining structure assistants include adhesive materials such as glue or tape; welding as in resistance welding, corona treatment and ultrasonic welding, or combinations thereof.

Where the plurality of adjoining structures consists of a tongue and a groove, the adjoining initiator tongue will have a first wall (275A), a second wall (275C) and a top (275B) and the adjoining receiver groove will have a first inside wall (270A), a second inside wall (270C) and a bottom (270B). The adjoining initiator tongue and the adjoining receiver groove may be designed such that the top is wider than the bottom so that the adjoining receiver groove will deform when the adjoining initiator tongue is inserted into the adjoining receiver groove (see FIG. 8) thereby locking the two or more longitudinal sections together and providing protection against separation of the two or more longitudinal sections.

In one embodiment, each longitudinal section may have a plurality of adjoining structures. In a further embodiment the plurality of adjoining structures consists of at least one adjoining initiator and at least one adjoining receiver. In such an embodiment, it is necessary that each adjoining initiator has a corresponding adjoining receiver on a different longitudinal section, however, it is not necessary that each adjoining receiver have a corresponding adjoining initiator on a different longitudinal section.

In a further embodiment, the at least one adjoining initiator and the at least one adjoining receiver alternate along the longitudinal section such that at least one of the at least one adjoining initiators of one longitudinal section mates with at least one of the at least one adjoining receivers of another longitudinal section. For example, one longitudinal section may have a plurality of alternating tongues and grooves, and at least one of said tongues mates with at least one groove of a second longitudinal section which also has a plurality of alternating tongues and grooves when the two longitudinal sections are connected to form the finished article.

Where the article of manufacture is an airplane seat back, the first leg section (210), the second leg section (220), and the top section (230) are all formed by adjoining together at least two longitudinal sections at a plurality of adjoining structures selected from the group consisting of an adjoining initiator (275), an adjoining receiver (270) or combinations thereof. In a more preferred embodiment, there are at least four longitudinal sections where the first longitudinal section (217) and the second longitudinal section (226) are mirror images and the third longitudinal section (216) and the fourth longitudinal section (227) are mirror images and at least a portion of the first adjoining structure of the first longitudinal section interacts with at least a portion of the second adjoining structure of the second longitudinal section and at least a portion of the third adjoining structure of the third longitudinal section to form the first leg section (210) and at least a portion of the top section (comprising 236 and 237 as seen in FIG. 3) and the second adjoining structure of the second longitudinal section interacts with at least a portion of the first adjoining structure of the first longitudinal section and at least a portion of the fourth adjoining structure of the fourth longitudinal section to form the second leg section (220) and at least a portion of the top section (comprising 238 and 239 as seen in FIG. 3).

### Increasing Strength

As described above, each longitudinal section will have a stress location when a pad-up is not utilized. This stress location can be determined by affixing one end of the longitudinal section and applying an increasing force to the other end of the longitudinal section and determining the point where the longitudinal section structurally fails. As described above, structurally fails means that the longitudinal section is permanently distorted from its original shape, which is usually observed as a kink, a collapse, or the propagation of a crack.

Once the longitudinal section stress location is determined, the longitudinal section thickness at the stress location can be increased to provide for additional thickness of the longitudinal section at the longitudinal section stress location, thereby increasing the strength of the longitudinal section. Alternatively, a pad-up may be added to the longitudinal section at the longitudinal section stress location.

The longitudinal section pad-up (150) will have a longitudinal section pad-up length dimension (183), a longitudinal section pad-up width dimension (153) and a longitudinal section pad-up height dimension (152) and will be affixed to the longitudinal section inside the longitudinal section and located at the longitudinal section stress location with the longitudinal section pad-up length dimension corresponding to the longitudinal section length dimension, the longitudinal section pad-up height dimension corresponding to the longitudinal section height dimension and the longitudinal section width dimension corresponding to the longitudinal section width dimension.

When two or more longitudinal sections are assembled to produce a finished article, it may be necessary to include a longitudinal section pad up in more than one of the two or more longitudinal sections to provide increased strength to the finished article. For instance, where the finished article is an airplane seat back, both legs of the airplane seat back may have a stress location. The stress location of the respective leg depends upon the leg design and how the leg is locked or permanently fixed. The stress location is the point where the leg structurally fails when an increasing force is applied to the top section (230) when the first and second leg sections are fixed so they do not move. Structurally fails means that the leg is permanently distorted from its original shape, which is usually observed as a kink, a collapse, or the propagation of a crack.

The increasing force is applied perpendicular to the “U” shaped member horizontal plane. In a preferred embodiment, the legs are made of the same mirror design and same dimensions and materials, so a force applied at the middle of the top section should cause both legs to fail at the same time in the same place. However, this is often not the case, and the force can be varied at different points along the top section to cause the leg of interest to fail before the other leg. Should a leg not fail, then its stress location is at the leg end furthest from the top section.

After determining the first leg section stress location and the second leg section stress location, the longitudinal section thickness of one or both of the two or more longitudinal sections that make up the legs may then be increased at the first leg section stress location and/or the second leg section stress location to provide additional longitudinal section thickness at the first leg section stress location and/or the second leg section stress location, thereby increasing the strength of the article of manufacture at the stress location(s) of interest.

In a preferred embodiment, once the first leg section stress location and the second leg section stress location are determined, a first leg section pad-up (150B) and/or a second leg section pad-up (150A) may be added to the one or both of the two or more longitudinal sections that make up the legs at the first leg section stress location and/or the second leg section stress location for additional strength. The first leg section pad-up is comprised of a thermoplastic matrix and oriented fibers and the second leg section pad-up is comprised of a thermoplastic matrix and oriented fibers. The first leg section pad-up and the second leg section pad-up may be comprised of the same thermoplastic matrix or different thermoplastic matrices.

The first leg section pad-up (150B) will have a first leg section pad-up length dimension (183), a first leg section pad-up width dimension (153) and a first leg section pad-up height dimension (152) and will be affixed to the first leg section inside the first leg section and located at the first leg section stress location with the first leg section pad-up length dimension corresponding to the first leg section length dimension, the first leg section pad-up height dimension corresponding to the first leg section height dimension and the first leg section width dimension corresponding to the first leg section width dimension.

The second leg section pad-up will have a second leg section pad-up length dimension, a second leg section pad-up width dimension and a second leg section pad-up height dimension and will be affixed to the second leg section inside the second leg section and located at the second leg section stress location with the second leg section pad-up length dimension corresponding to the second leg section length dimension, the second leg section pad-up height dimension corresponding to the second leg section height dimension and the second leg section width dimension corresponding to the second leg section width dimension.

In a preferred embodiment, there will also be a top section pad-up (150C) having a top section pad-up length dimension, a top section pad-up width dimension and a top section pad-up height dimension and affixed to the top section inside the top section and located at the top section stress location with the top section pad-up length dimension corresponding to the top section length dimension, the top section pad-up height dimension corresponding to the top section height dimension and the top section width dimension corresponding to the top section width dimension. The top section pad-up may comprise the same thermoplastic matrix as the first leg section pad-up and or the second leg section pad-up or a different thermoplastic matrix than both the first leg section pad-up matrix and the second leg section pad-up matrix.

Although not necessary, a pad-up should have at least one hole or perforation (162), and it is preferable to have a plurality of perforations, at least some of which serve to physically locate a pad-up to the side of a leg section and/or the top section. This could be the inside or outside of a leg and/or the top section. During molding formation of the leg and/or the top section, a portion of the thermoplastic material of the leg and/or top section will extend through at least some of the perforations embedding the edges of the perforations in the thermoplastic material extending there through, thereby fixedly attaching the pad-up to the leg and/or top section as well as melt bonding the thermoplastic of the pad-up with the thermoplastic matrix of the leg and/or top section. In another embodiment, the thermoplastic will mold through the perforations or aperatures and form and bond with the thermoplastic material on the other side of the pad-up, thereby more permanently affixing or connecting the pad-up to the leg and/or top section thermoplastic.

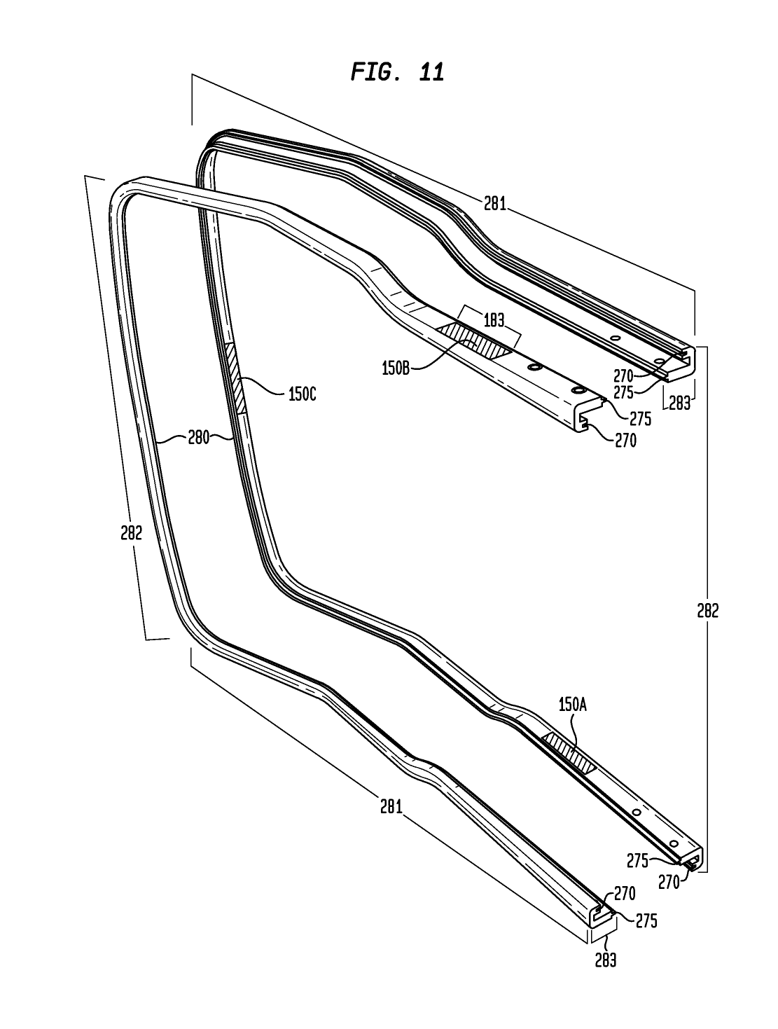

The leg and/or top section may also include a plurality of reinforcing ribs (FIG. 12, 160) located within the hollow interior of the channel (231). At least a portion of the reinforcing ribs are formed by molding of the thermoplastic material so that at least a portion of the plastic material extends through at least some of the perforations of the pad-up. These reinforcing ribs may have configurations selected from, but not limited to, X-like configurations, zig-zag configurations, curved or arcuate configurations, parallel configurations and combinations thereof.

If more bonding is needed, the pad-up can be corona or flame treated to modify the surface area to be more bondable with the thermoplastic of the leg and/or top section. The best bond strength is expected when the matrix material of the pad-up is the same thermoplastic matrix of the leg and/or top section. The increased strength of the assembly at the respective stress location will be in part a function of the number of holes or perforations in the pad-up, the diameter or thickness of the holes or perforations, and whether the material of the pad-up is corona or flame treated. The strength increase will also be a function of the length of the pad-up, the height of the pad-up, the width of the pad-up and the known structural strength relationships of oriented fibers, the degree of orientation, fiber choice and fiber density. Because the preferred manufacturing techniques are over molding and/or insert molding the pad-up into the leg and/or the top section, the pad-up is affixed to the leg and/or top section by melt bonding.

It will be understood by the skilled artisan that the use of a pad-up is not limited to the “U” shaped structure airplane seat back embodiments. In other embodiments, a pad-up may be affixed to at least one of the longitudinal sections to provide increased strength in areas of the assembled article that structurally fail under stress. Such pad-ups may be affixed to at least one of the longitudinal sections by insert molding or over molding

### Thermoplastic Materials

The pad-up will be made from a thermoplastic material or a thermoset material. (as used herein and in the claims the term “thermoset plastic material” or “thermoset” means plastic materials having a three dimensional cross linked network resulting from the formation of covalent bonds between chemically reactive groups, e.g., active hydrogen groups and free isocyanate groups or oxirane groups). Thermoset plastic materials may be fabricated by processes known to the skilled artisan, e.g., cross linked polyurethanes, cross linked polyepoxides and cross linked polyesters. For purposes of illustration, a thermoset may be fabricated from cross linked polyurethanes by the art-recognized process of reaction injection molding. Reaction injection molding typically involves, as is known to the skilled artisan, injecting separately, and preferably simultaneously, into a mold: (i) an active hydrogen functional component (e.g., a polyol and/or polyamine); and (ii) a functional component that forms covalent bonds with the active hydrogen functional component, such as an isocyanate functional component (e.g., a diisocyanate such as toluene diisocyanate, and/or dimers and trimers of a diisocyanate such as toluene diisocyanate). The filled mold may optionally be heated to ensure and/or hasten complete reaction of the injected components. Upon complete reaction of the injected components, the mold is opened and the molded article with pad-up is removed.

Preferably the pad-up(s) and the at least two longitudinal sections should be made of thermoplastic matrices (as used herein and in the claims, the term “thermoplastic material” or thermoplastic matrix means a plastic material or matrix that has a softening or melting point, and is substantially free (having less than 5% by weight of the plastic material as part of the thermoplastic matrix) of a three dimensional cross linked network resulting from the formation of covalent bonds between chemically reactive groups, e.g., active hydrogen groups and free isocyanate groups). The thermoplastic material may contain a dispersion of ground thermoset, but the continuous matrix phase itself will be substantially free or void of thermoset materials. In one embodiment, the pad-up(s) may be made of thermoset plastic matrices while the at least two longitudinal sections are made of thermoplastic matrices.

Examples of thermoplastic materials from which the at least two longitudinal sections and the pad-up(s) may be fabricated include, but are not limited to, thermoplastic polyphenylene sulfide, thermoplastic polyetheretherketone, thermoplastic polyetherketoneketone, thermoplastic polyether imide, thermoplastic polyurethane, thermoplastic polyurea, thermoplastic polyimide, thermoplastic polyamide, thermoplastic polyamideimide, thermoplastic polyester, thermoplastic polycarbonate, thermoplastic polysulfone, thermoplastic polyketone, thermoplastic polypropylene, thermoplastic acrylonitrile-butadiene-styrene and mixtures, thermoplastic polyethersulfone or thermoplastic compositions containing one or more and their copolymers thereof.

Of the thermoplastic materials from which the at least two longitudinal sections and the pad-up(s) may be fabricated, thermoplastic polyamides and thermoplastic polysulfones are preferred. The at least two longitudinal sections may be fabricated from thermoplastic materials by the art-recognized process of injection molding, in which a molten stream of thermoplastic material, e.g., molten thermoplastic polyamide, is injected into a mold, e.g., an optionally heated mold.

The thermoset plastic materials and/or thermoplastic materials from which the pad-up(s) may be fabricated, are reinforced with a type of oriented fibers selected from the group consisting of glass type fibers, carbon type fibers, metal type fibers, polyamide type fibers and mixtures thereof. The reinforcing fibers, and the glass type fibers in particular, may have sizings on their surfaces to improve miscibility and/or adhesion to the plastics into which they are incorporated, as is known to the skilled artisan.

The thermoplastic materials from which the longitudinal sections may be fabricated are often reinforced with a plurality of randomly dispersed fiber types selected from the group consisting of glass fibers, carbon fibers, metal fibers, polyamide fibers and mixtures thereof. The plurality of randomly dispersed fiber types may be the same type of fiber as those of the oriented fibers in the pad-up thermoplastic matrix. In one such embodiment, the randomly dispersed fibers originate as pre-pregs and are chopped or cut into smaller, randomly dispersed fibers prior to being introduced to the longitudinal section(s).

Carbon type fibers are a preferred reinforcing material in the present invention. If used, the reinforcement material, e.g., the fibers are typically present in the thermoset plastic materials and/or thermoplastic materials of the pad-up in a reinforcing amount, e.g., in an amount of from 5 percent by weight to 60 percent by weight, based on the total weight of the leg pad-up(s).

The carbon type fibers used to form the pad-up(s) may have an average fiber diameter of 4 micrometers to 12 micrometers. One suitable carbon type fiber is from Zoltek Corporation of St Louis, Mo. USA, and has the trade name Panex 35. Other suitable carbon type fibers are from Hexcel Corporation of Stamford, Conn. USA, and include AS4 carbon fibers and IM7 carbon fibers. The fiber volume fraction may be 0.5 to 0.7 of the composite leg pad-up(s). In the case of nano-fibers, diameters of 2 to 12 microns are typical.

To obtain the strength required, the fibers in the pad-up(s) are preferably continuous fibers and oriented or highly aligned in different parallel planes of the pad-up(s). These planes are also called plies. One method of manufacturing the thermoplastic pad-up(s) is to take a series of individual plies which are thermoplastic materials having oriented fibers running their length and lay the plies one on top of the other. The oriented fibers can have a different orientation of one ply relative to another ply. These various plies are often referred to as pre-pregs and are available on the open market, usually in rolls. Once the plies have been laid one on top of the other, heat and pressure can be applied to melt and press the plies together in a strong structural bond. This pressing could be done to create a flat sheet from which the pad-up could be cut, or the plies could be precut, laid into a mold and the pressure and heat applied. A continuous manufacturing operation of this type is described in DE 4017978, the teachings of which are incorporated herein.

The oriented fiber in a ply may also be woven with fibers in the ply so that many fibers are aligned in a first direction, the other fibers are aligned in a direction different from the first direction, but in the same direction considered a second direction, passing over and under the fibers aligned in the first direction and are thus woven with the fibers aligned in the first direction.

The oriented fibers will form a plane within the thermoplastic matrix of the pad-up(s). If many plies of fibers are used, the plies will be separate planes. The oriented fibers will have an orientation direction. While the oriented fibers in one plane or ply may be rotated or offset relative to the oriented fibers in another plane or ply, at any given point in the pad-up, the oriented fibers in one ply will not be oriented in a direction that traverses into another ply. Often times only a uni-directional orientation is needed. It is also possible that the thermoplastic matrix used to surround the oriented fibers may further comprise chopped or dispersed fibers as well.

When a pad-up is affixed to a longitudinal section, the pad-up fibers are aligned so that the pad-up length dimension lies substantially parallel to the side of the longitudinal section formed from the first end to the second end. Substantially parallel means that the pad-up length dimension is not perpendicular to the side of the longitudinal section length dimension, or does not pass through both sides of the longitudinal section in a perpendicular manner.

In a preferred embodiment the pad-up(s) will have at least one hole or perforation and the thermoplastic matrix material of the longitudinal section(s) will pass through holes of the pad-up(s) and be molded around the inserted pad-up(s). The pad-up hole or aperture does not have to be round, but could be of hexagonal or even rectangular or square design to prevent turning about the hole.

The actual molding of an injection moldable material around a pre-fabricated core or insert, such as a pad-up, is well known in the art. U.S. Pat. No. 6,251,323, incorporated herein by reference, describes how to totally encapsulate the pre-fabricated material. The background section of U.S. Pat. No. 6,251,323 describes various other types of injection molding processes to injection mold a material onto a prefabricated part, such as a pad-up.

It should be clear to one of ordinary skill how using the much stronger directionally oriented fibers of the leg pad-up placed at and into areas of stress locations allows for an injection molded seat back to be quickly made and assembled. The invention is not limited to the embodiments disclosed but to all equivalents using the principles taught herein.

FIG. 10 shows how the leg pad-up 150A, 150B, or top section pad-up 150C may be affixed to the outside of the leg or top section. In this instance the pad-up is placed on the outside of the wall of the mold and the thermoplastic matrix injection molded or over molded onto and through any holes of the leg pad-up.

Because this invention may use thermoplastics which are inherently flame retardant, the use of additional flame retardants is not considered necessary. Thus, the article of this invention is halogen free, meaning that the total amount of halogens which are not present as catalyst for the thermoplastic material, is less than 1% by weight of the total composition halogens. The amount of halogen is the amount of material as halogen, not the amount of Halogen compound.

Each of the two or more longitudinal sections is comprised of a thermoplastic matrix comprised of randomly dispersed fibers. While conceptually the thermoplastics comprising each of the two or more longitudinal sections may be different, it is preferable that the thermoplastics be the same. These randomly dispersed fibers are also chopped fibers. Such thermoplastic compounds containing these fibers are obtainable from PolyOne Corporation (USA) as AS41 and IM7 grades.

Of the randomly dispersed fiber materials from which the longitudinal sections may be fabricated, carbon fibers, glass fibers or polyaramide fibers are preferred with carbon fibers being most preferred. In a preferred embodiment, the randomly dispersed fibers in the thermoplastic matrix is between 5% and 60% by weight of the at least two longitudinal sections.

1-37. (canceled)

38. An article of manufacture comprising:
at least a first longitudinal section and a section longitudinal section, wherein
the first longitudinal section has a first longitudinal section length dimension, a first longitudinal section width dimension, a first longitudinal section height dimension, one or more first longitudinal section thicknesses, two first longitudinal section edges corresponding to the first longitudinal section length dimension and a first thermoplastic matrix comprised of randomly dispersed fibers of the first longitudinal section, the first longitudinal section further comprising;
at least one first adjoining structure selected from the group consisting of an adjoining initiator, an adjoining receiver or combinations thereof
the second longitudinal section has a second longitudinal section length dimension, a second longitudinal section width dimension, a second longitudinal section height dimension, one or more second longitudinal section thicknesses, two second longitudinal section edges corresponding to the second longitudinal section length dimension and a second thermoplastic matrix comprised of randomly dispersed fibers of the second longitudinal section, the second longitudinal section further comprising;
at least one second adjoining structure selected from the group consisting of an adjoining initiator, an adjoining receiver or combinations thereof
the at least one first adjoining structure is designed to interact with the at least one second adjoining structure such that the at least one first adjoining structure joins with the at least one second adjoining structure to form an assembly comprising at least the first longitudinal section and the second longitudinal section;
wherein the assembly comprises a channel having a bottom, side walls, and a top each having interior surfaces which define a hollow interior.

39. The article of manufacture of claim 38, wherein the at least first longitudinal section and second longitudinal section are produced by injection molding.

40. The article of manufacture of claim 38, wherein at least one of the first longitudinal section and the second longitudinal section comprises at least one pad-up comprised of a third thermoplastic matrix and oriented fibers.

41. The article of manufacture of claim 40, wherein the at least one pad-up is affixed to at least one of the first longitudinal section and the second longitudinal section by over molding.

42. The article of manufacture of claim 40, wherein the at least one pad-up is affixed to at least one of the first longitudinal section and the second longitudinal section by insert molding.

43. The article of manufacture of claim 40, wherein the oriented fibers comprises a fiber type selected from the group consisting of carbon fibers, glass fibers, polyaramide fibers and combinations thereof.

44. The article of manufacture of claim 38, wherein the first adjoining structure and the second adjoining structure are selected from the group consisting of an adjoining initiator tongue and an adjoining receiver groove; an adjoining initiator pin and an adjoining receiver pin receiver; an adjoining initiator tab and an adjoining receiver tab receiver.

45. The article of manufacture of claim 38, wherein the first adjoining structure and the second adjoining structure further comprise an adjoining structure assistant selected from the group consisting of an adhesive material, welding or combinations thereof.

46. The article of manufacture of claim 38, wherein the at least one first adjoining structure comprises a plurality of first adjoining structures and the at least one second adjoining structure comprises a plurality of second adjoining structures.

47. The article of manufacture of claim 46, wherein the plurality of first adjoining structures consists of at least one adjoining structure initiator and at least one adjoining structure receiver which alternate along at least a portion of at least one edge of the first longitudinal section and the plurality of second adjoining structures consists of at least one adjoining structure initiator and at least one adjoining structure receiver which alternate along at least a portion of at least one edge of the second longitudinal section.

48. The article of manufacture of claim 38, wherein the first adjoining structure runs the entire length of at least one edge of the first longitudinal section and the second adjoining structure runs the entire length of at least one edge of the second longitudinal section.

49. The article of manufacture of claim 38, wherein the first thermoplastic matrix, the second thermoplastic matrix and the third thermoplastic matrix each comprise a thermoplastic selected from the group consisting of polyphenylene sulphide, polyetherimide, polyetheretherketone, polyetherketoneketone, polyethylene terephthalate, polyester, polybutylene terephthalate, polyethylene naphthalate, polyethersulfone and combinations thereof.

50. The article of manufacture of claim 38, wherein the randomly dispersed fiber types of the first thermoplastic matrix and the second thermoplastic matrix each comprise a fiber type selected from the group consisting of carbon fibers, glass fibers, polyaramide fibers and combinations thereof.

51. The article of manufacture of claim 38, wherein the amount of randomly dispersed fibers in the first thermoplastic matrix and the second thermoplastic matrix is each between 5% and 60% by weight of the respective first and second longitudinal sections.

52. A process to manufacture an article comprising the steps of:
A) Molding at least a first longitudinal section and a second longitudinal section wherein,
the first longitudinal section has a first longitudinal section length dimension, a first longitudinal section width dimension, a first longitudinal section height dimension, one or more first longitudinal section thicknesses, and a first thermoplastic matrix comprised of randomly dispersed fibers, the first longitudinal section further comprising;
at least one first adjoining structure selected from the group consisting of an adjoining initiator, an adjoining receiver or combinations thereof
the second longitudinal section has a second longitudinal section length dimension, a second longitudinal section width dimension, a second longitudinal section height dimension, one or more second longitudinal section thicknesses, and a second thermoplastic matrix comprised of randomly dispersed fibers, the second longitudinal section further comprising;
at least one second adjoining structure selected from the group consisting of an adjoining initiator, an adjoining receiver or combinations thereof
B) Adjoining the at least a first longitudinal section and a second longitudinal section at at least the first adjoining structure and the second adjoining structure to form one continuous article of manufacture.

53. The process of claim 52, wherein the first adjoining structure and the second adjoining structure are selected from the group consisting of an adjoining initiator tongue and an adjoining receiver groove; an adjoining initiator pin and an adjoining receiver pin receiver; an adjoining initiator tab and an adjoining receiver tab receiver or combinations thereof.

54. The process of claim 52, wherein the first adjoining structure and the second adjoining structure further comprise an adjoining structure assistant selected from the group consisting of an adhesive material, welding or combinations thereof.

55. The process of claim 52, wherein molding the thermoplastic matrix comprised of random fibers into at least the first longitudinal section and the second longitudinal section comprises injection molding.

56. The process of claim 52, wherein at least one of the at least a first longitudinal section and a second longitudinal section further comprises at least one pad-up comprised of a third thermoplastic matrix and oriented fibers.

57. The process of claim 52, wherein the oriented fibers comprise a fiber type selected from the group consisting of carbon fibers, glass fibers, polyaramide fibers and combinations thereof.

58. The process of claim 52, wherein the first thermoplastic matrix, the second thermoplastic matrix and the third thermoplastic matrix each comprise a thermoplastic selected from the group consisting of polyphenylene sulphide, polyetherimide, polyetheretherketone, polyetherketoneketone, polyethylene terephthalate, polyester, polybutylene terephthalate, polyethylene naphthalate, polyethersulfone and combinations thereof.

58. The process of claim 52, wherein the randomly dispersed fibers comprise a fiber type selected from the group consisting of carbon fiber, glass fiber, polyaramide fiber and combinations thereof.

59. The process of claim 56, wherein the at least one pad-up is over molded into the at least a first longitudinal section or a second longitudinal section.

60. The process of claim 56, wherein the at least one pad-up is insert molded into the at least a first longitudinal section or a second longitudinal section.
